(19) United States
(12) Patent Application Publication
(10) Pub. No.: US 2026/0098719 A1
(43) Pub. Date: Apr. 9, 2026

(54) SELF-TRACEABLE TWO-DIMENSIONAL (2D) DISPLACEMENT MEASUREMENT DEVICE

(71) Applicant: National Institute of Metrology, China, Beijing (CN)

(72) Inventors: Yushu SHI, Beijing (CN); Shu ZHANG, Beijing (CN); Fang WANG, Beijing (CN); Qiyuan GAO, Beijing (CN)

(73) Assignee: National Institute of Metrology, China, Beijing (CN)

(21) Appl. No.: 19/345,919

(22) Filed: Sep. 30, 2025

(30) Foreign Application Priority Data
Oct. 9, 2024 (CN) 202411404850.8

(51) Int. Cl. G01B 11/00; G01B 1/00; G02B 5/18

(52) U.S. Cl. CPC G01B 11/005; G01B 1/00; G02B 5/1814; G02B 5/1866; G02B 2207/101

(57) ABSTRACT

Self-traceable two-dimensional (2D) displacement measurement devices are provided. In some examples, a self-traceable 2D displacement measurement device includes: a first radiation source, a second radiation source, a wafer fixation plate, a first silicon wafer, a second silicon wafer, a third silicon wafer, a first radiation detector, a second radiation detector, and an XY 2D displacement platform. The self-traceable 2D displacement measurement device includes a displacement measurement module in an X-direction and a displacement measurement module in a Y-direction. The first silicon wafer and the second silicon wafer are fixed on the wafer fixation plate in parallel; the third silicon wafer is parallel to the second silicon wafer; a distance from the third silicon wafer to the second silicon wafer is the same as that from the first silicon wafer to the second silicon wafer; the third silicon wafer is fixed on a sidewall of the XY 2D displacement platform.

### CROSS REFERENCE TO RELATED APPLICATION

This patent application claims the benefit and priority of Chinese Patent Application No. 2024114048508, filed with the China National Intellectual Property Administration on October 09, 2024, the disclosure of which is incorporated by reference herein in its entirety as part of the present application.

### TECHNICAL FIELD

The present disclosure relates to the technical field of precise displacement measurement, and in particular to a self-traceable two-dimensional (2D) displacement measurement device.

### BACKGROUND

With the development of high-end manufacturing, increasingly high requirements are imposed on nanometric high-precision displacement measurement technologies. At present, high-precision 2D displacement measurement devices mainly comprise a 2D grating displacement measurement system. For the 2D grating displacement measurement system, the processing quality of the grating is highly demanded, the whole structure is complex, and the measurement result cannot be directly traced to the definition of the meter. Consequently, in some measurement occasions, particularly measurement occasions with a resolution and a precision highly demanded, the 2D grating displacement measurement system meets the measurement requirements hardly.

### SUMMARY

According to a first aspect, the present disclosure provides a self-traceable 2D displacement measurement device. The self-traceable 2D displacement measurement device comprises: a first radiation source, a second radiation source, a wafer fixation plate, a first silicon wafer, a second silicon wafer, a third silicon wafer, a first radiation detector, a second radiation detector, and an XY 2D displacement platform; and the first silicon wafer comprises a first lattice plane and a second lattice plane that are perpendicular to each other;

the first radiation source, the first silicon wafer, the second silicon wafer, the third silicon wafer and the first radiation detector constitute a displacement measurement module in an X-direction;

the second radiation source, the first silicon wafer, the second silicon wafer, the third silicon wafer and the second radiation detector constitute a displacement measurement module in a Y-direction;

the first silicon wafer and the second silicon wafer are fixed on the wafer fixation plate in parallel, the third silicon wafer is parallel to the second silicon wafer, and a distance from the third silicon wafer to the second silicon wafer is the same as a distance from the first silicon wafer to the second silicon wafer; and

the third silicon wafer is fixed on a sidewall of the XY 2D displacement platform, the XY 2D displacement platform is configured to drive the third silicon wafer to displace together, and during displacement, the third silicon wafer and the second silicon wafer keep parallel and the distance from the third silicon wafer to the second silicon wafer remains unchanged.

Optionally, the first silicon wafer and the second silicon wafer are identical in terms of planar size, thickness and lattice direction.

Optionally, a size of the third silicon wafer is greater than a size of the first silicon wafer and a size of the second silicon wafer.

Optionally, a measurement principle of the displacement measurement module in the X-direction specifically comprises:

a ray emitted from the first radiation source is incident on the first lattice plane of the first silicon wafer at a Bragg angle and undergoes Laue diffraction, splitting into two beams of first diffracted light; the two beams of first diffracted light are incident on the second silicon wafer and undergo Laue diffraction again, generating second diffracted light; the second diffracted light is converged at the third silicon wafer to generate an interference fringe; as the third silicon wafer moves with the XY 2D displacement platform along the X-direction, an intensity of an interference signal received by the first radiation detector changes sinusoidally; each time the third silicon wafer moves along the X-direction by a distance equal to a spacing of the first lattice plane of the first silicon wafer, the interference signal changes one cycle; and a number of cycles for the received interference signal is multiplied by a spacing of the first lattice plane involved in diffraction along the X-direction to obtain a displacement of the third silicon wafer along the X-direction.

Optionally, a measurement principle of the displacement measurement module in the Y-direction specifically comprises:

a ray emitted from the second radiation source is incident on the second lattice plane of the first silicon wafer at a Bragg angle and undergoes Laue diffraction, splitting into two beams of third diffracted light; the two beams of third diffracted light are incident on the second silicon wafer and undergo Laue diffraction again, generating fourth diffracted light; the fourth diffracted light is converged at the third silicon wafer to generate an interference fringe; as the third silicon wafer moves with the XY 2D displacement platform along the Y-direction, an intensity of an interference signal received by the second radiation detector changes sinusoidally; each time the third silicon wafer moves along the Y-direction by a distance equal to a spacing of the second lattice plane of the first silicon wafer, the interference signal changes one cycle; and a number of cycles for the received interference signal is multiplied by a spacing of the second lattice plane involved in diffraction along the Y-direction to obtain a displacement of the third silicon wafer along the Y-direction.

Optionally, a target material of the first radiation source is copper (Cu), with an excited ray at a wavelength of 0.154 nm.

Optionally, a target material of the second radiation source is Cu, with an excited ray at a wavelength of 0.154 nm.

Optionally, a target material of the first radiation source is molybdenum (Mo), with an excited ray at a wavelength of 0.071 nm.

Optionally, a target material of the second radiation source is Mo, with an excited ray at a wavelength of 0.071 nm.

Optionally, the first silicon wafer comprises any one of a {220} lattice plane and a {111} lattice plane/a {100} lattice plane and a {010} lattice plane/a {100} lattice plane and a {001} lattice plane/a {100} lattice plane and a {011} lattice plane.

According to specific embodiments provided in the present disclosure, the present disclosure has the following technical effects:

The present disclosure provides a self-traceable 2D displacement measurement device, comprising: a first radiation source, a second radiation source, a wafer fixation plate, a first silicon wafer, a second silicon wafer, a third silicon wafer, a first radiation detector, a second radiation detector, and an XY 2D displacement platform. The first silicon wafer comprises a first lattice plane and a second lattice plane that are perpendicular to each other. The first radiation source, the first silicon wafer, the second silicon wafer, the third silicon wafer and the first radiation detector constitute a displacement measurement module in an X-direction. The second radiation source, the first silicon wafer, the second silicon wafer, the third silicon wafer and the second radiation detector constitute a displacement measurement module in a Y-direction. The first silicon wafer and the second silicon wafer are fixed on the wafer fixation plate in parallel. The third silicon wafer is parallel to the second silicon wafer. A distance from the third silicon wafer to the second silicon wafer is the same as a distance from the first silicon wafer to the second silicon wafer. The third silicon wafer is fixed on a sidewall of the XY 2D displacement platform. The XY 2D displacement platform is configured to drive the third silicon wafer to displace together. During displacement, the third silicon wafer and the second silicon wafer keep parallel and the distance from the third silicon wafer to the second silicon wafer remains unchanged. The present disclosure may realize the 2D displacement measurement at the same time. Meanwhile, since the spacing of the lattice plane is at the sub-nanometer scale, and the measurement device is based on the spacing of the lattice plane, the sub-nanometric measurement resolution may be achieved, and the measurement result may be directly traced to the definition of the meter.

### BRIEF DESCRIPTION OF THE DRAWINGS

To describe the technical solutions in embodiments of the present disclosure or in the prior art more clearly, the accompanying drawings required for the embodiments are briefly described below. Apparently, the accompanying drawings in the following description show merely some embodiments of the present disclosure, and those of ordinary skill in the art may still derive other accompanying drawings from these accompanying drawings without creative efforts.

FIG. 1 is an overall schematic structural view of a self-traceable 2D displacement measurement device according to an embodiment of the present disclosure.

FIG. 2 is a schematic view of a displacement measurement principle in an X-direction according to an embodiment of the present disclosure.

FIG. 3 is a schematic view of a displacement measurement principle in a Y-direction according to an embodiment of the present disclosure.

Reference numerals: 101-first radiation source, 102-second radiation source, 201-wafer fixation plate, 202-first silicon wafer, 203-second silicon wafer, 3-third silicon wafer, 401-first radiation detector, 402-second radiation detector, and 5-XY 2D displacement platform.

### DETAILED DESCRIPTION OF THE EMBODIMENTS

The technical solutions in the embodiments of the present disclosure are described below with reference to the drawings in the embodiments of the present disclosure. The embodiments described are merely a part rather than all of the embodiments of the present disclosure. All other embodiment obtained by a person of ordinary skill in the art based on the embodiments of the present disclosure without creative efforts shall fall within the protection scope of the present disclosure.

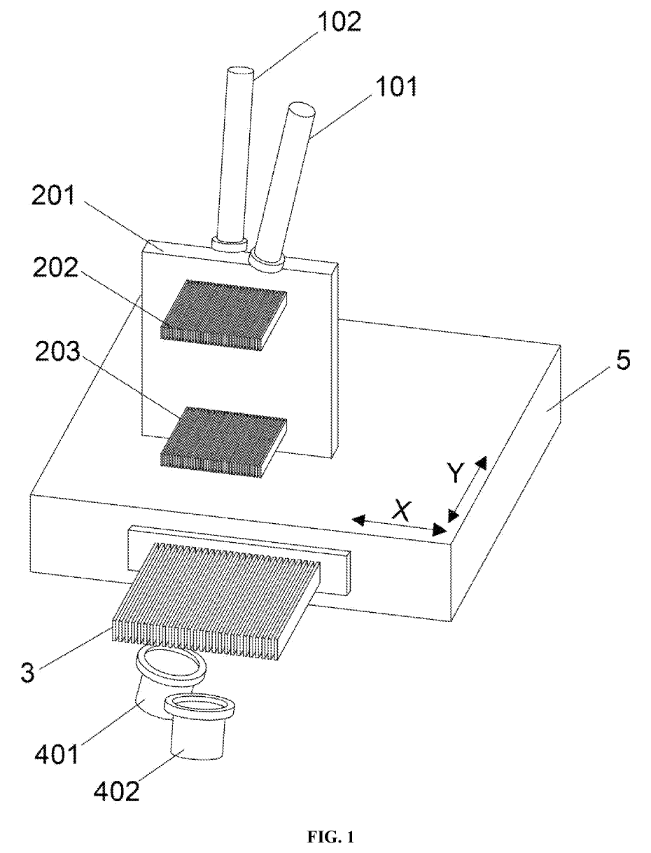

In an exemplary embodiment, as shown in FIG. 1, a self-traceable 2D displacement measurement device is provided. The self-traceable 2D displacement measurement device comprises: a first radiation source 101, a second radiation source 102, a wafer fixation plate 201, a first silicon wafer 202, a second silicon wafer 203, a third silicon wafer 3, a first radiation detector 401, a second radiation detector 402, and an XY 2D displacement platform 5. The first silicon wafer 202 comprises a first lattice plane and a second lattice plane that are perpendicular to each other.

The first radiation source 101, the first silicon wafer 202, the second silicon wafer 203, the third silicon wafer 3 and the first radiation detector 401 constitute a displacement measurement module in an X-direction.

The second radiation source 102, the first silicon wafer 202, the second silicon wafer 203, the third silicon wafer 3 and the second radiation detector 402 constitute a displacement measurement module in a Y-direction.

The first silicon wafer 202 and the second silicon wafer 203 are fixed on the wafer fixation plate 201 in parallel. The third silicon wafer 3 is parallel to the second silicon wafer 203 (namely the first silicon wafer 202, the second silicon wafer 203 and the third silicon wafer 3 are parallel to each other). A distance from the third silicon wafer 3 to the second silicon wafer 203 is the same as a distance from the first silicon wafer 202 to the second silicon wafer 203.

The third silicon wafer 3 is fixed on a sidewall of the XY 2D displacement platform 5. The XY 2D displacement platform 5 is configured to drive the third silicon wafer 3 to displace together. During displacement, the third silicon wafer 3 and the second silicon wafer 203 keep parallel and the distance from the third silicon wafer to the second silicon wafer remains unchanged.

As an optional implementation, the first silicon wafer 202 and the second silicon wafer 203 are identical in terms of planar size, thickness and lattice direction.

As an optional implementation, a size of the third silicon wafer 3 is greater than a size of the first silicon wafer 202 and a size of the second silicon wafer 203. The specific size is not limited, and depends on the measurement range. If a wider measurement range is required, the size of the third silicon wafer 3 may be increased appropriately.

As an optional implementation, a target material of the first radiation source 101 and a target material of the second radiation source 102 are Cu, with an excited ray at a wavelength of 0.154 nm.

It is to be noted that the target material of the first radiation source 101 and the target material of the second radiation source 102 are not limited to Cu, and may also be Mo with an excited ray at a wavelength of 0.071 nm, or other target materials with excited rays at other wavelengths. The wavelength of the radiation source mainly depends on absorption of the silicon crystal to rays at this wavelength and an intensity of diffracted light.

As an optional implementation, the first silicon wafer 202 comprises any one of a {220} lattice plane and a {111} lattice plane/a {100} lattice plane and a {010} lattice plane/a {100} lattice plane and a {001} lattice plane/a {100} lattice plane and a {011} lattice plane.

It is to be noted that except the listed lattice planes of the silicon wafer, other lattice planes perpendicular to each other may also be selected to realize the 2D displacement measurement described in the present disclosure. Since the {220} lattice plane and the {111} lattice plane have a relatively high diffraction intensity, the {220} lattice plane and the {111} lattice plane are selected as lattice planes of the first silicon wafer 202.

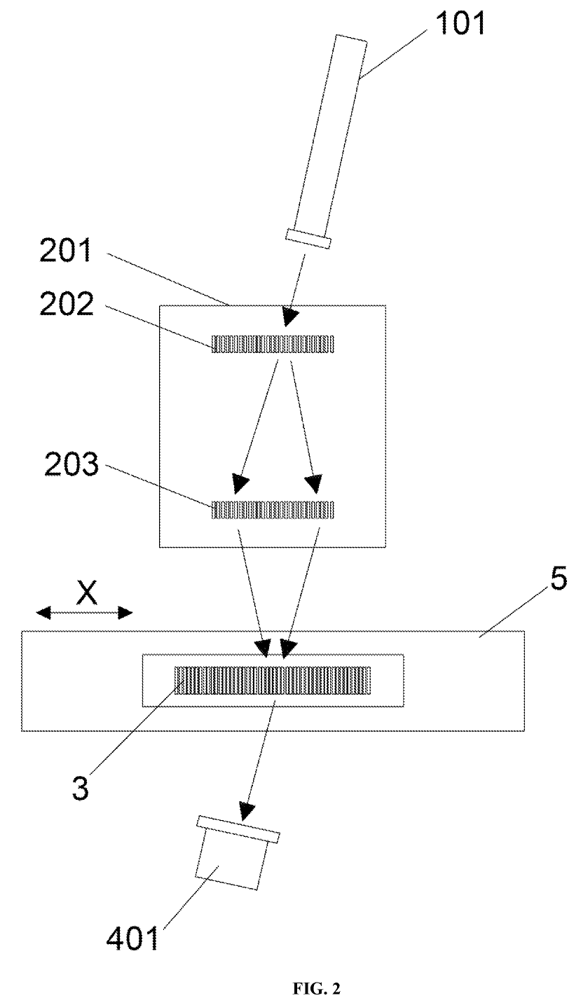

As shown in FIG. 2, a measurement principle of the displacement measurement module in the X-direction specifically comprises:

A ray emitted from the first radiation source 101 is incident on the first lattice plane of the first silicon wafer 202 at a Bragg angle and undergoes Laue diffraction, splitting into two beams of first diffracted light. The two beams of first diffracted light are incident on the second silicon wafer 203 and undergo Laue diffraction again, generating second diffracted light. The second diffracted light is converged at the third silicon wafer 3 to generate an interference fringe. As the third silicon wafer 3 moves with the XY 2D displacement platform 5 along the X-direction, an intensity of an interference signal received by the first radiation detector 401 changes sinusoidally. Each time the third silicon wafer 3 moves along the X-direction by a distance equal to a spacing of the first lattice plane of the first silicon wafer, the interference signal changes one cycle. A number of cycles for the received interference signal is multiplied by a spacing of the first lattice plane involved in diffraction along the X-direction to obtain a displacement of the third silicon wafer 3 along the X-direction.

Specifically, a Cu ray emitted from the first radiation source 101 is incident on the first silicon wafer 202 at a Bragg angle. The Cu ray has a wavelength of 0.154 nm. The spacing of the {220} lattice plane in silicon is 0.19202 nm. According to a Bragg equation d sinθ = nλ (d is a lattice spacing, θ is an incident angle, n is a diffraction order, and λ is a wavelength of incident light), the calculated incident angle is 23.641° (in this equation, when the wavelength of the radiation source and the lattice spacing of the silicon are determined, and n is 1, constructive interference cannot occur, unless the corresponding calculated incident angle is satisfied. In case of other incident angles, an intensity of diffracted light is affected. The incident angle is merely a necessary condition for the diffraction. The finally calculated displacement is only associated with the spacing of the {220} lattice plane). The Cu ray undergoes Laue diffraction at the first silicon wafer 202, splitting into two beams of first diffracted light. The two beams of first diffracted light are incident on the second silicon wafer 203 and undergo Laue diffraction again, generating second diffracted light. The second diffracted light is converged at the third silicon wafer 3 to generate an interference fringe. As the third silicon wafer 3 moves with the XY 2D displacement platform 5 along the X-direction, an intensity of an interference signal received by the first radiation detector 401 changes sinusoidally. Each time the third silicon wafer 3 moves along the X-direction by a distance equal to the spacing of the lattice plane, the interference signal changes one cycle. A number of cycles for the received signal is calculated and multiplied by the spacing of the {220} lattice plane in the silicon to obtain a displacement of the third silicon wafer 3 along the X-direction.

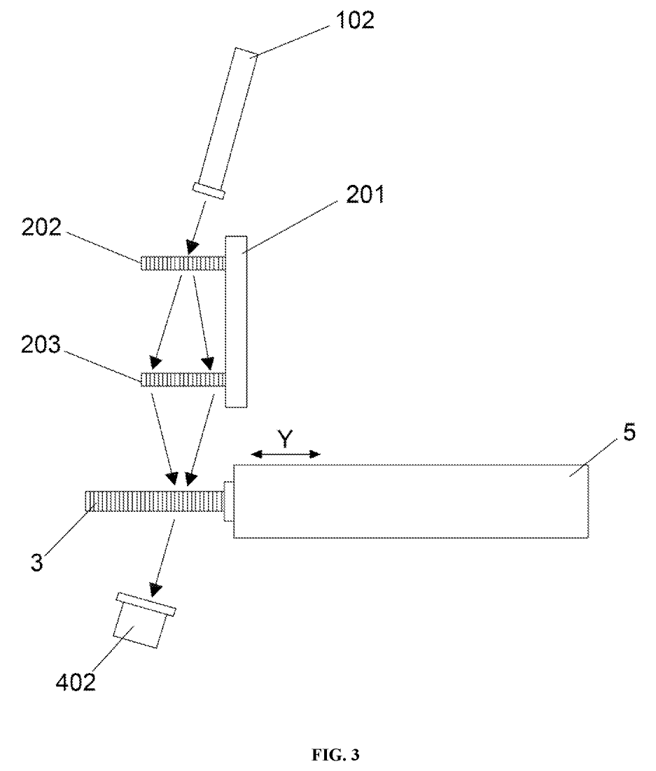

As shown in FIG. 3, a measurement principle of the displacement measurement module in the Y-direction specifically comprises:

A ray emitted from the second radiation source 102 is incident on the second lattice plane of the first silicon wafer 202 at a Bragg angle and undergoes Laue diffraction, splitting into two beams of third diffracted light. The two beams of third diffracted light are incident on the second silicon wafer 203 and undergo Laue diffraction again, generating fourth diffracted light. The fourth diffracted light is converged at the third silicon wafer 3 to generate an interference fringe. As the third silicon wafer 3 moves with the XY 2D displacement platform 5 along the Y-direction, an intensity of an interference signal received by the second radiation detector 402 changes sinusoidally. Each time the third silicon wafer 3 moves along the Y-direction by a distance equal to a spacing of the second lattice plane of the first silicon wafer, the interference signal changes one cycle. A number of cycles for the received interference signal is multiplied by a spacing of the second lattice plane involved in diffraction along the Y-direction to obtain a displacement of the third silicon wafer 3 along the Y-direction.

Specifically, a Cu ray emitted from the second radiation source 102 is incident on the first silicon wafer 202 at a Bragg angle. The Cu ray has a wavelength of 0.154 nm. The spacing of the {111} lattice plane in silicon is 0.31356 nm. According to a Bragg equation d sinθ = nλ, the calculated incident angle is 14.215°. The Cu ray undergoes Laue diffraction at the first silicon wafer 202, splitting into two beams of third diffracted light. The two beams of third diffracted light are incident on the second silicon wafer 203 and undergo Laue diffraction again, generating fourth diffracted light. The fourth diffracted light is converged at the third silicon wafer 3 to generate an interference fringe. As the third silicon wafer 3 moves with the XY 2D displacement platform 5 along the Y-direction, an intensity of an interference signal received by the second radiation detector 402 changes sinusoidally. Each time the third silicon wafer 3 moves along the Y-direction by a distance equal to the spacing of the lattice plane, the interference signal changes one cycle. A number of cycles for the received signal is calculated and multiplied by the spacing of the {111} lattice plane in the silicon to obtain a displacement of the third silicon wafer 3 along the Y-direction.

Various embodiments of the disclosure may have one or more of the following effects. In some embodiments, an objective of the present disclosure may be to provide a self-traceable 2D displacement measurement device, which may realize 2D displacement measurement at the same time, may achieve a sub-nanometric measurement resolution, and may directly trace a measurement result to the definition of meter. In other embodiments, when compared with the prior art, the present disclosure may have one or more of the following advantages and beneficial effects.

(1) The 2D displacement measurement may be realized at the same time, the sub-nanometric measurement resolution may be achieved, and the measurement result may be directly traced to the definition of the meter (since the spacing of the {220} lattice plane is 0.225 nm and is at the sub-nanometer scale, and the measurement method is based on the spacing of the {220} lattice plane in the silicon, the sub-nanometric measurement resolution may also be achieved, and spacings of other lattice planes in the silicon are also at the sub-nanometer scale) (According to the 26th General Conference on Weights and Measures (CGPM) in 2018, the spacing of the {220} lattice plane in the silicon is used as a reproduction method for the definition of the meter).

(2) The spatial structure is compact. The two radiation sources and the two radiation detectors share the same group of silicon wafers to realize the 2D displacement measurement, effectively improving the space utilization rate.

(3) The measurement range is wide. The third silicon wafer, the first silicon wafer and the second silicon wafer are split. The measurement range of the device depends on a range of movement of the XY 2D displacement measurement platform, and the measurement range is wide.

The technical characteristics of the above embodiments may be employed in arbitrary combinations. To provide a concise description of these embodiments, all possible combinations of all the technical characteristics of the above embodiments may not be described. However, these combinations of the technical characteristics should be construed as falling within the scope defined by the specification as long as no contradiction occurs.

Specific examples are used herein to explain the principles and implementations of the present disclosure. The description of the embodiments is merely intended to help understand the method of the present disclosure and its core ideas. In addition, those of ordinary skill in the art may make various modifications to the specific implementations and application scope in accordance with the teachings of the present disclosure. In conclusion, the content of the description shall not be construed as limitations to the present disclosure.

What is claimed is:

1. A self-traceable two-dimensional (2D) displacement measurement device, comprising: a first radiation source, a second radiation source, a wafer fixation plate, a first silicon wafer, a second silicon wafer, a third silicon wafer, a first radiation detector, a second radiation detector, and an XY 2D displacement platform, wherein:
the first silicon wafer comprises a first lattice plane and a second lattice plane that are perpendicular to each other;
the first radiation source, the first silicon wafer, the second silicon wafer, the third silicon wafer, and the first radiation detector constitute a displacement measurement module in an X-direction;
the second radiation source, the first silicon wafer, the second silicon wafer, the third silicon wafer, and the second radiation detector constitute a displacement measurement module in a Y-direction;
the first silicon wafer and the second silicon wafer are fixed on the wafer fixation plate in parallel, the third silicon wafer is parallel to the second silicon wafer, and a distance from the third silicon wafer to the second silicon wafer is the same as a distance from the first silicon wafer to the second silicon wafer; and
the third silicon wafer is fixed on a sidewall of the XY 2D displacement platform, the XY 2D displacement platform is configured to drive the third silicon wafer to displace together, and during displacement, the third silicon wafer and the second silicon wafer are parallel and the distance from the third silicon wafer to the second silicon wafer remains unchanged.

2. The self-traceable 2D displacement measurement device according to claim 1, wherein the first silicon wafer and the second silicon wafer are identical in terms of planar size, thickness, and lattice direction.

3. The self-traceable 2D displacement measurement device according to claim 2, wherein a size of the third silicon wafer is greater than a size of the first silicon wafer and a size of the second silicon wafer.

4. The self-traceable 2D displacement measurement device according to claim 1, wherein a measurement principle of the displacement measurement module in the X-direction specifically comprises:
a ray emitted from the first radiation source is incident on the first lattice plane of the first silicon wafer at a Bragg angle and undergoes Laue diffraction, splitting into two beams of first diffracted light;
the two beams of first diffracted light are incident on the second silicon wafer and undergo Laue diffraction again, generating second diffracted light;
the second diffracted light is converged at the third silicon wafer to generate an interference fringe;
as the third silicon wafer moves with the XY 2D displacement platform along the X-direction, an intensity of an interference signal received by the first radiation detector changes sinusoidally;
each time the third silicon wafer moves along the X-direction by a distance equal to a spacing of the first lattice plane of the first silicon wafer, the interference signal changes one cycle; and
a number of cycles for the received interference signal is multiplied by a spacing of the first lattice plane involved in diffraction along the X-direction to obtain a displacement of the third silicon wafer along the X-direction.

5. The self-traceable 2D displacement measurement device according to claim 1, wherein a measurement principle of the displacement measurement module in the Y-direction specifically comprises:
a ray emitted from the second radiation source is incident on the second lattice plane of the first silicon wafer at a Bragg angle and undergoes Laue diffraction, splitting into two beams of third diffracted light;
the two beams of third diffracted light are incident on the second silicon wafer and undergo Laue diffraction again, generating fourth diffracted light;
the fourth diffracted light is converged at the third silicon wafer to generate an interference fringe;
as the third silicon wafer moves with the XY 2D displacement platform along the Y-direction, an intensity of an interference signal received by the second radiation detector changes sinusoidally;
each time the third silicon wafer moves along the Y-direction by a distance equal to a spacing of the second lattice plane of the first silicon wafer, the interference signal changes one cycle; and
a number of cycles for the received interference signal is multiplied by a spacing of the second lattice plane involved in diffraction along the Y-direction to obtain a displacement of the third silicon wafer along the Y-direction.

6. The self-traceable 2D displacement measurement device according to claim 1, wherein a target material of the first radiation source is copper (Cu), with an excited ray at a wavelength of 0.154 nm.

7. The self-traceable 2D displacement measurement device according to claim 1, wherein a target material of the second radiation source is Cu, with an excited ray at a wavelength of 0.154 nm.

8. The self-traceable 2D displacement measurement device according to claim 1, wherein a target material of the first radiation source is molybdenum (Mo), with an excited ray at a wavelength of 0.071 nm.

9. The self-traceable 2D displacement measurement device according to claim 1, wherein a target material of the second radiation source is Mo, with an excited ray at a wavelength of 0.071 nm.

10. The self-traceable 2D displacement measurement device according to claim 1, wherein the first silicon wafer comprises any one of a {220} lattice plane and a {111} lattice plane/a {100} lattice plane and a {010} lattice plane/a {100} lattice plane and a {001} lattice plane/a {100} lattice plane and a {011} lattice plane.
